(19) United States
(12) Patent Application Publication
(10) Pub. No.: US 2017/0244848 A1
(43) Pub. Date: Aug. 24, 2017

(54) IMAGE FORMING APPARATUS, INFORMATION PROCESSING APPARATUS, IMAGE FORMING METHOD, AND COMPUTER PROGRAM

(71) Applicant: CANON KABUSHIKI KAISHA, Tokyo (JP)

(72) Inventor: Yoshihiro Tsukada, Toride-shi (JP)

(21) Appl. No.: 15/438,558

(22) Filed: Feb. 21, 2017

(30) Foreign Application Priority Data
Feb. 23, 2016 (JP) 2016-031682

(51) Int. Cl. H04N 1/00

(52) U.S. Cl. CPC H04N 1/00464; H04N 1/00204; H04N 1/00411; H04N 1/00424; H04N 2201/0094

(57) ABSTRACT

There is provided an image forming apparatus in which a URL and print setting information are stored in association with a functional button (URL print button) for performing URL printing, and are displayed on a display unit in the image forming apparatus, and a user can perform printing in a print setting adapted to a target document only by pressing a functional button which is being displayed.

### BACKGROUND

Field of the Disclosure

The present disclosure relates to an image processing apparatus having image processing functions such as a printing function and a reading function, an information processing apparatus which outputs a job for causing the image processing apparatus to perform image processing, an image processing system, and a program. More specifically, the present disclosure relates to a technique for executing a job by performing data communication between an image processing apparatus and an information processing apparatus to execute a job.

Description of the Related Art

In recent years, a user's demand to print a web page on an Internet website has been growing. In the case, an image forming apparatus such as a printer has been generally instructed to print data on the web page from an information processing apparatus such as a personal computer (PC) accessible to the web page. However, depending on the web page, a high-function browser is required to perform printing. If there is no high-function browser in such a case, printing cannot be performed. Therefore, according to Japanese Patent Application Laid-Open No. 2001-228987, when a server having a browser function is provided between an image forming apparatus and the Internet, the image forming apparatus acquires a web page via a server connected to the Internet in response to an instruction from an information processing apparatus, to perform print output.

In a technique discussed in Japanese Patent Application Laid-Open No. 2001-228987, when a user prints the web page, a Universal Resource Locator (URL) of the web page needs to be input each time. When a user wishes to change a print setting for each web page, the print setting needs to be changed each time. Thus, a usability problem remains in Japanese Patent Application Laid-Open No. 2001-228987.

### SUMMARY

The present disclosure is mainly directed to providing a technique for resolving a problem of usability.

According to an aspect of the present disclosure, an image forming apparatus includes a holding unit configured to hold identification information about a functional image in which access information for enabling acquisition of data from the outside and setting information about image formation of the data are associated with each other, a display unit configured to display the functional image specified by the identification information on a predetermined operation screen, an operation acceptance unit configured to accept an operation for the functional image which is being displayed, a data acquisition unit configured to acquire the data using the access information associated with the functional image, triggered by the acceptance of the operation, and an image forming unit configured to form an image according to the setting information for the acquired data.

Further features of the present disclosure will become apparent from the following description of exemplary embodiments with reference to the attached drawings.

### BRIEF DESCRIPTION OF THE DRAWINGS

FIG. 1 illustrates a hardware configuration of an image processing system according to one or more aspects of the present disclosure.

FIG. 2 illustrates a functional configuration of a multi function peripheral (MFP) according to one or more aspects of the present disclosure.

FIG. 3 illustrates a functional configuration of a personal computer (PC) according to one or more aspects of the present disclosure.

FIG. 4 illustrates a registration screen of a Universal Resource Locator (URL) print button according to one or more aspects of the present disclosure.

FIG. 5 illustrates the URL print button registered on a home screen according to one or more aspects of the present disclosure.

FIG. 6 illustrates an index table according to one or more aspects of the present disclosure.

FIG. 7 illustrates a correspondence table according to one or more aspects of the present disclosure.

FIG. 8 illustrates a procedure for registering a URL print button with a registration unit according to one or more aspects of the present disclosure.

FIG. 9 illustrates a procedure for performing URL printing by the MFP according to one or more aspects of the present disclosure.

### DESCRIPTION OF THE EMBODIMENTS

Exemplary embodiments of the present disclosure will be described below with reference to the drawings.

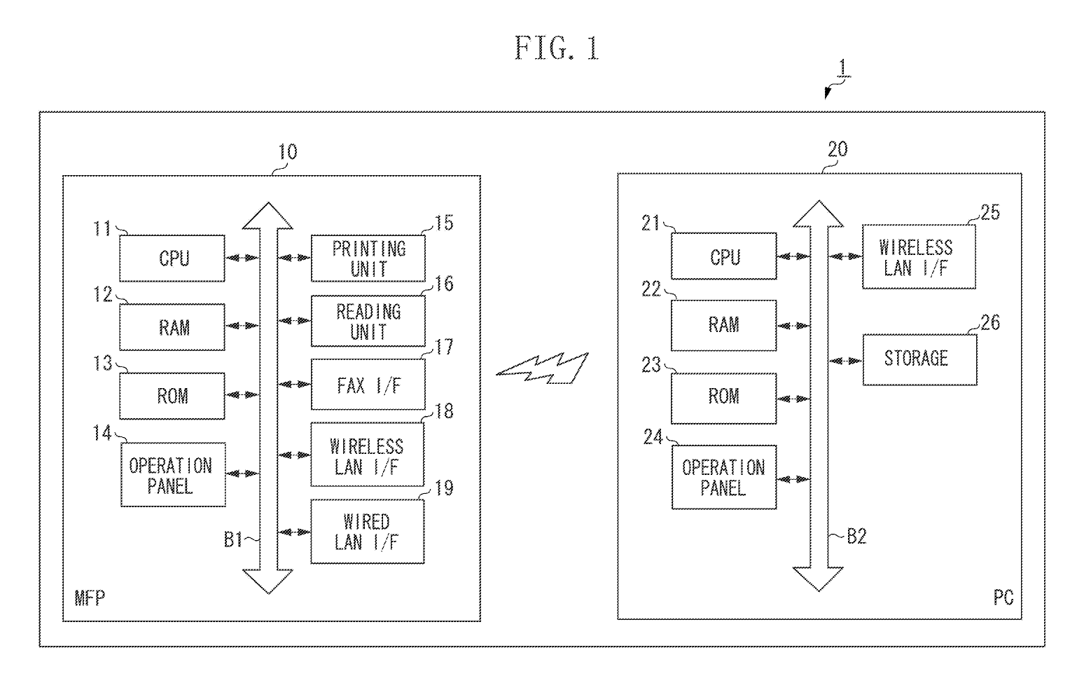

FIG. 1 is a configuration diagram of an entire image processing system according to a first exemplary embodiment. An image processing system 1 includes a multi function peripheral (MFP) 10 which is an example of an image forming apparatus and a personal computer (PC) 20 which is an example of an information processing apparatus. The MFP 10 has a scan function, a print function, and a facsimile function as basic functions. The PC 20 has a function of causing the MFP 10 to execute jobs such as a scan job, print job, and a facsimile job. The MFP 10 and the PC 20 are connected to each other via wireless communication, and each of them regards another as an external apparatus.

The MFP 10 includes a computer including a central processing unit (CPU) 11, a random access memory (RAM) 12, and a read-only memory (ROM) 13 each mutually connected to a system bus B1, as a hardware resource as illustrated in FIG. 1. The CPU 11 executes a predetermined computer program, to control components in the MFP 10. The RAM 12 is a volatile memory, and is used as a temporary storage area such as a main memory or a work area in the CPU 11. The ROM 13 is a nonvolatile memory. The ROM 13 stores the above-described computer program, a utility program to enable start and execution of the computer program, control data, and read-only initial data. The computer program executed by the CPU 11 may be previously stored not in the ROM 13 but in an external memory (e.g., a hard disk).

In addition, an operation panel 14, a printing unit 15, a reading unit 16, a facsimile-interface (FAX-I/F) 17, a wireless local area network (LAN)-I/F 18, and a wired LAN-I/F 19 are connected to the system bus B1. The operation panel 14 is loaded with a touch panel, and displays a screen for displaying a message and a setting content for a user. A user input is accepted via the screen. A functional graphics is displayed on the screen. This will be described below. The printing unit 15 is a printing mechanism for printing an image on a predetermined sheet as an example of image formation. The reading unit 16 is a reading mechanism for reading (scanning) an image on a document placed on a document positioning plate (not illustrated). The FAX-I/F 17 is an I/F which enables communication with a facsimile apparatus (not illustrated) via a public line (not illustrated). The facsimile apparatus also has an image forming function, like the printing unit 15. The wireless LAN-I/F 18 is an I/F which enables wireless communication with the external apparatus including the PC 20 based on an international standard, i.e., Institute of Electrical and Electronic Engineers (IEEE) 802.11 and a standard conforming thereto, for example. The wired LAN-I/F 19 is an I/F which enables wired communication with the external apparatus.

A hardware configuration of the PC 20 will be described below. The PC 20 includes a computer including a CPU 21, a RAM 22, a ROM 23, and a storage 26 serving as a hardware resource to which a system bus B2 is connected. The PC 20 includes a touch panel type operation panel 24 implementing both a display function and an input function and a wireless LAN-I/F 25 serving as a communication I/F which enables communication with the external apparatus. An operating system (OS) executable by the CPU 21, a browser for browsing a file on the Internet, and a device driver which controls various types of devices are incorporated into the storage 26. An application program for causing the MFP 10 to make print, send a fax, and e-mail data stored in the PC 20 is also stored in the storage 26. The application program operates on the OS, and is hereinafter referred to as an “MFP application”. The MFP application may be configured such that a HyperText Markup Language (HTML) content generated by the MFP 10 is stored in the storage 26 and displayed with a browser.

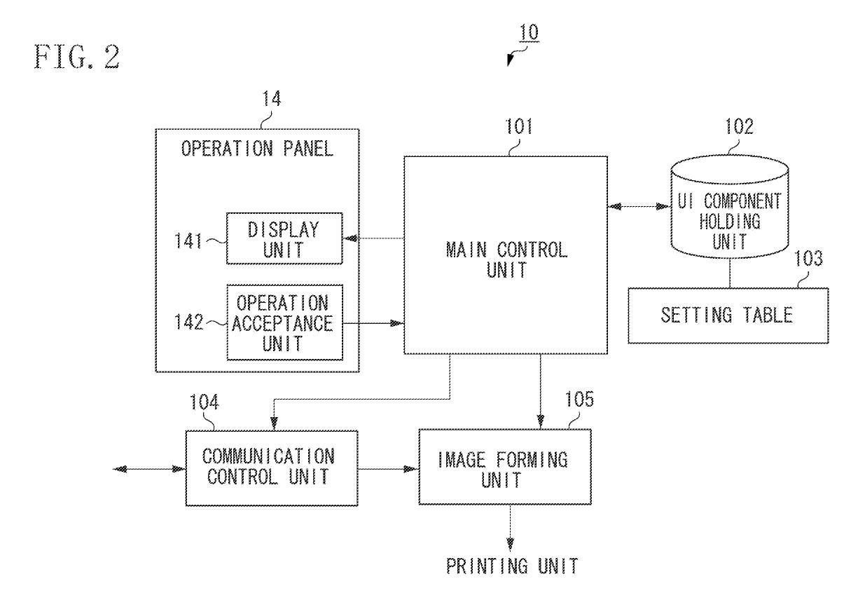

Functional blocks formed in the MFP 10 and the PC 20 will be described below. FIG. 2 is a configuration diagram of the functional blocks formed in the MFP 10, and illustrates portions other than the basic functions. In the present exemplary embodiment, when the CPU 11 in the MFP 10 executes a computer program stored in the RAM 12 or the ROM 13, to form functions of a main control unit 101, a UI component holding unit 102, a setting table 103, a communication control unit 104, and an image forming unit 105 in the MFP 10.

A display unit 141 is a display in the operation panel 14, and functions as a display unit. An operation acceptance unit 142 is a known touch screen in the operation panel 14, and functions as an operation acceptance unit. In the present exemplary embodiment, one or more functional images each specified by identification information are displayed on the display unit 141. The operation acceptance unit 142 accepts a user's operation for the functional image which is being displayed.

The functional image is an image with which access information enabling acquisition of data from the outside and setting information about image formation performed for the data are associated. The functional image is particularly referred to as a function button when it is a button-shaped image. The function button is one type of user interface (UI) component displayed on the display unit 141. The function button is created or edited by the PC 20, and is transmitted to the MFP 10. The MFP 10 holds the function button in the UI component holding unit 102. Identification information about the function button received from the PC 20, the access information, and the image formation setting information are associated with one another, and are held in the setting table 103.

The access information is a URL for getting to the web page when a data acquisition destination is a web page and includes an IP address of a relay device when the relay device intervenes. If the web page is a page which can be browsed via a specific web browser, and the web browser is provided in only the external apparatus (e.g., the PC 20), the access information is a URL accessible via the external apparatus. The access information may include login information including a user name and a password required to display the web page, and cookie information about the web page.

In the present exemplary embodiment, an example of “URL printing” is taken as a function to be assigned to the function button. The URL printing means referring to a URL of an area where data exists to acquire the data, and printing the acquired data. A user's request to perform the above-described URL printing is referred to as a “URL printing request”. If the user's request is the URL printing request, a character string indicating that the user's request is the URL printing request and a URL for reaching a data acquisition destination are transmitted to the PC 20, to request data acquisition. A function button to which the URL printing request is assigned is referred to as a “URL print button” in the present exemplary embodiment.

The communication control unit 104 functions as a data acquisition unit which controls the FAX-I/F 17, the wireless LAN-I/F 18, and the wired LAN-I/F 19, and acquires data from a facsimile apparatus or an external apparatus connected to a wireless LAN or a wired LAN. The communication control unit 104 refers to access information associated with the above-described URL print button, to acquire data, for example. The image forming unit 105 forms an image according to setting information for the acquired data. The printing unit 15 prints the formed image.

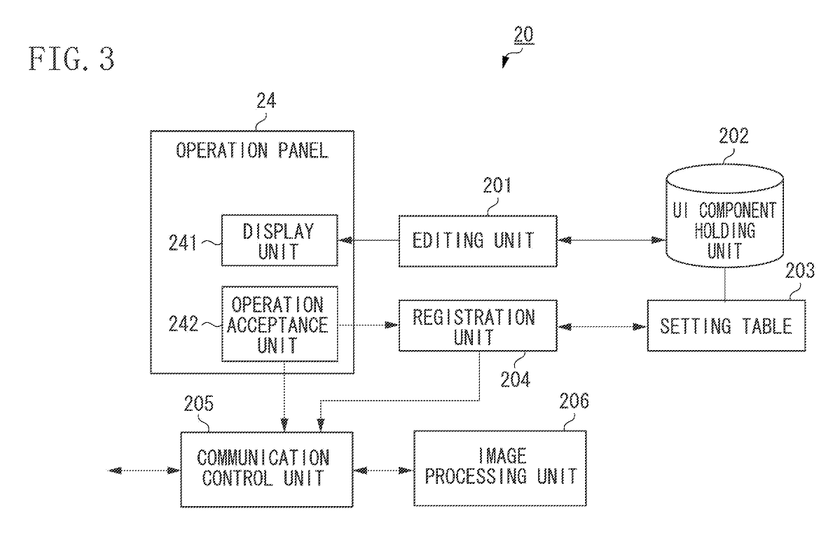

FIG. 3 is a configuration diagram of functional blocks formed in the PC 20, and illustrates a portion related to image formation. In the present exemplary embodiment, when the CPU 21 in the PC 20 executes a computer program stored in the storage 26, to form the functions of an editing unit 201, a UI component holding unit 202, a setting table 203, a communication control unit 205, and an image processing unit 206 in the PC 20. A display unit 241 is a display in the operation panel 24, and functions as a display unit. An operation acceptance unit 242 is a known touch screen in the operation panel 24, and functions as an operation acceptance unit. For example, the operation acceptance unit 242 accepts a user's operation of a function button (a URL print button, etc.) which is being displayed.

The editing unit 201 edits the layout of an operation screen displayed on the display unit 241 using a UI component held in the UI component holding unit 202. The registration unit 204 performs processing for registering a functional image, e.g., the above-described URL print button. The URL print button is registered via the display unit 241 and the operation acceptance unit 242 in the operation panel 24. A registered content is held in the setting table 203. The setting table 203 includes an index table and a correspondence table, described below, for example. The communication control unit 205 controls the wireless LAN-I/F, and receives and transfers data from and to a web page or an external apparatus connected to a wireless LAN, e.g., the MFP 10. Browsing of the web page and acquisition of data from the web page are performed via a web browser. The image processing unit 206 transmits the registered URL print button (functional image) to the MFP 10 to display the URL print button (functional image) on the operation panel 14. The image processing unit 206 performs image processing on the data acquired via the communication control unit 205.

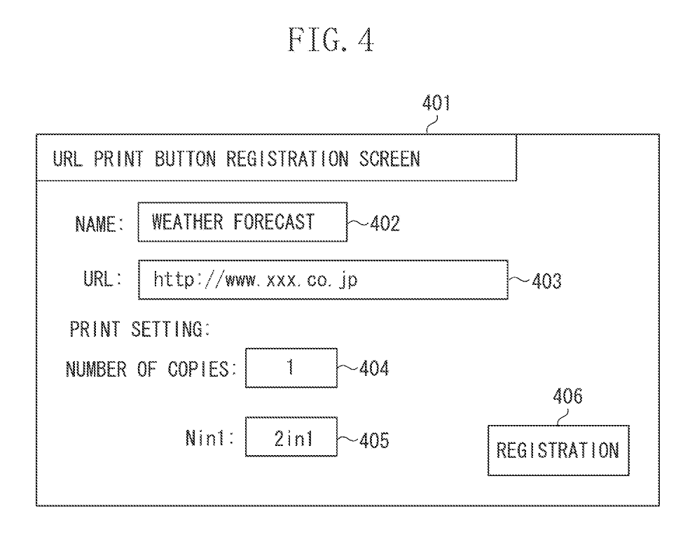

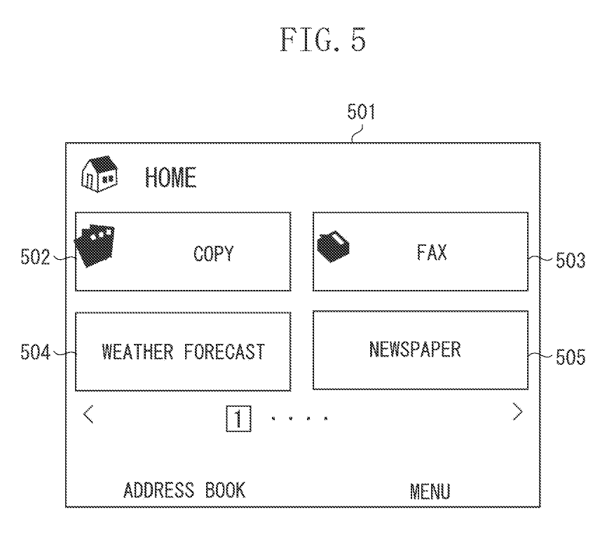

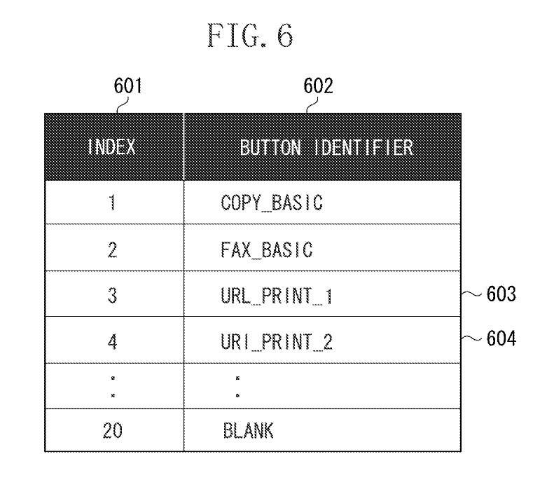

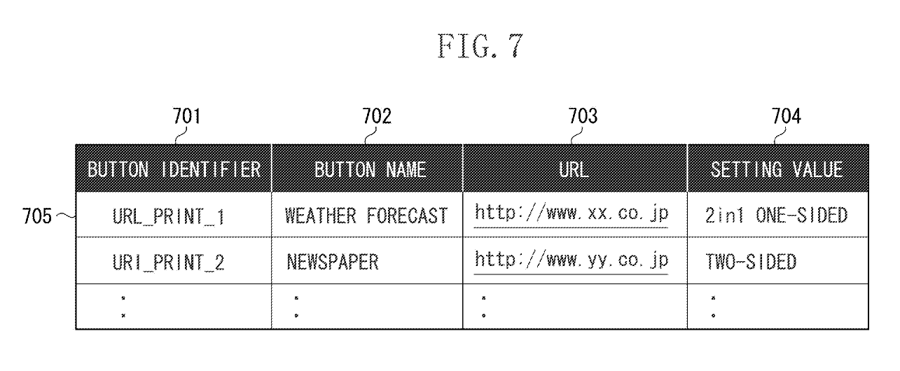

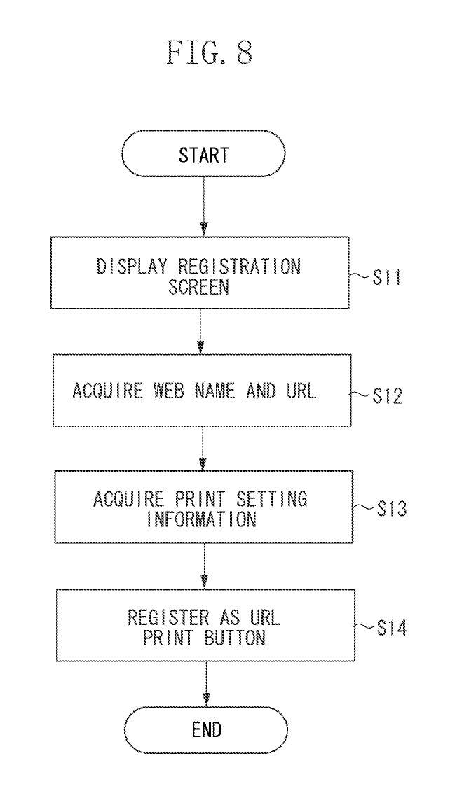

The registration processing in the registration unit 204 will be specifically described below. A case where the URL print button is registered by the registration unit 204, and information about the registered URL print button is transmitted to the MFP 10 and is made displayable on the operation panel 14 will be described below as an example. The registration processing is performed via a registration screen displayed on the display unit 241 in the PC 20. FIG. 4 illustrates an example of the registration screen. FIG. 5 illustrates an example of a home screen displayed on the display unit 141 in the MFP 10. FIGS. 6 and 7 illustrate examples of the setting table 203. FIG. 8 illustrates a procedure for the registration processing performed by the registration unit 204.

Referring to FIG. 8, in step S11, the registration unit 204 displays a registration screen 401 illustrated in FIG. 4. In step S12, the registration unit 204 acquires a web name and a URL. In step S13, the registration unit 204 acquires print setting information. In step S14, the registration unit 204 registers the acquired information, respectively, as URL print buttons.

In the example illustrated in FIG. 4, the PC 20 displays the registration screen 401 the layout of which has been edited by the editing unit 201 on the display unit 241. The editing unit 201 forms a name input (column) 402 of a URL print button, a URL input column 403, a number-of-copies input column 404 at the time of a print setting, an Nin1 input column 405, and a registration button 406. The name input column 402 is a column into which an identification name of a web page optionally set by the user and changeable afterward is input. In the illustrated example, a web page “weather forecast” is set. The URL input column 403 is a column into which a target URL for the URL print button is input. In the illustrated example, a URL of the web page on which information about weather forecast appears is set. The copy number input column 404 is a column into which the image formation setting information, e.g., the number of copies in the print setting is input. The Nin1 input column 405 is a column for designating a reduction layout in the print setting. This is also one of the image formation setting information. As a setting content, a reduction layout in which N pages (N is a natural number) are printed on one side of a sheet for a single copy is set in the MFP 10. In the illustrated example, two pages are printed on one side of a sheet. Types of setting items are not limited to the number of copies and the reduction layout. All setting items in the MFP 10 and setting items which can be designated and printed from an external application such as a driver for the MFP 10, fall within target subjects. The registration button 406 is a function button to which a function of registering (recording) the values input to the above-described columns 402 to 405 in the setting table 203 is assigned.

When the MFP 10 is started up, a home screen is displayed on the operation panel 14. FIG. 5 illustrates an example of the home screen. Various types of function buttons are displayed on a home screen 501. In the illustrated example, a copy button 502, a fax button 503, a weather forecast button 504, and a newspaper button 505 are displayed as function buttons. The copy button 502 is the function button for shifting to a setting screen for the copy function which is the basic function of the MFP 10. The fax button 503 is the function button for shifting to a setting screen for the facsimile function which is another basic function. The weather forecast button 504 and the newspaper button 505 are URL print buttons registered via the URL print button registration screen 401. When the weather forecast button 504 is pressed, the MFP 10 acquires information about weather forecast as print data from a web page accessible by a registered URL, triggered by the pressing of the button. The weather forecast button 504 requests the printing unit 15 to perform printing according to contents of the registered print settings 404 and 405. The newspaper button 505 requests the printing unit 15 to perform URL printing based on registered information, like the weather forecast button 504.

FIG. 6 illustrates an example of an index table. In the illustrated example, an arrangement position of a URL print button and a button identifier for uniquely identifying the URL print button are associated with each other. The arrangement position of the URL print button is written in an index (column) 601. Rows (or columns) are prepared in the index 601 corresponding to the number of function buttons which can be arranged on one screen. An identifier for the function button corresponding to the index 601 is written in a button identifier (column) 602. When there exists no function button corresponding to the index 601, “BLANK” is written.

In the example illustrated in FIG. 6, “COPY_BASIC” for identifying a “copy button” serving as a function button assigned a copy function is associated with “index 1”. “BASIC” indicates that the assigned function is a basic function of the MFP 10. “FAX_BASIC” for identifying a “fax button” serving as a function button to which a facsimile function is assigned is associated with “index 2”. “URL_PRINT_1” for identifying a web page “weather forecast” is associated with “index 3”, and “URL_PRINT_2” for identifying a web page “newspaper” is associated with “index 4”. “URL_PRINT_1” and “URL_PRINT_2” are each a button identifier indicating that the function button is a URL print button, and are registered (recorded) via the registration screen 401 illustrated in FIG. 4. When a URL print button is newly added, URL_PRINT_N (N is a natural number) is arranged as a new button identifier in the row (or column) corresponding to the smallest index number in the index column 601 among the rows (or columns) in which “BLANK” is written.

FIG. 7 illustrates an example of a correspondence table associated with the button identifier 602. In the illustrated example, a button identifier (column) 701 having the same content as the button identifier 602 illustrated in FIG. 6, and a button name (column) 702, a URL (column) 703, and a setting value (column) 704, which correspond to the button identifier 701, are formed. A content of the correspondence table is updated when the registration button 406 in the registration screen 401 illustrated in FIG. 4 is pressed. In the button identifier 701, a column of a URL corresponding to the URL print button, for example, is set.

The button name 702, the URL 703, and the setting value 704 respectively correspond to the name input column 402 illustrated in FIG. 4, the URL 403, and the print setting columns 404 and 405. When weather forecast information is recorded as the URL print button, for example, the button identifier 602 (701) is “URL_PRINT_1”, the button name 702 is “weather forecast”, the URL 703 is “http://www.xxx.co.jp”, and the setting value is “2in1 one-sided”.

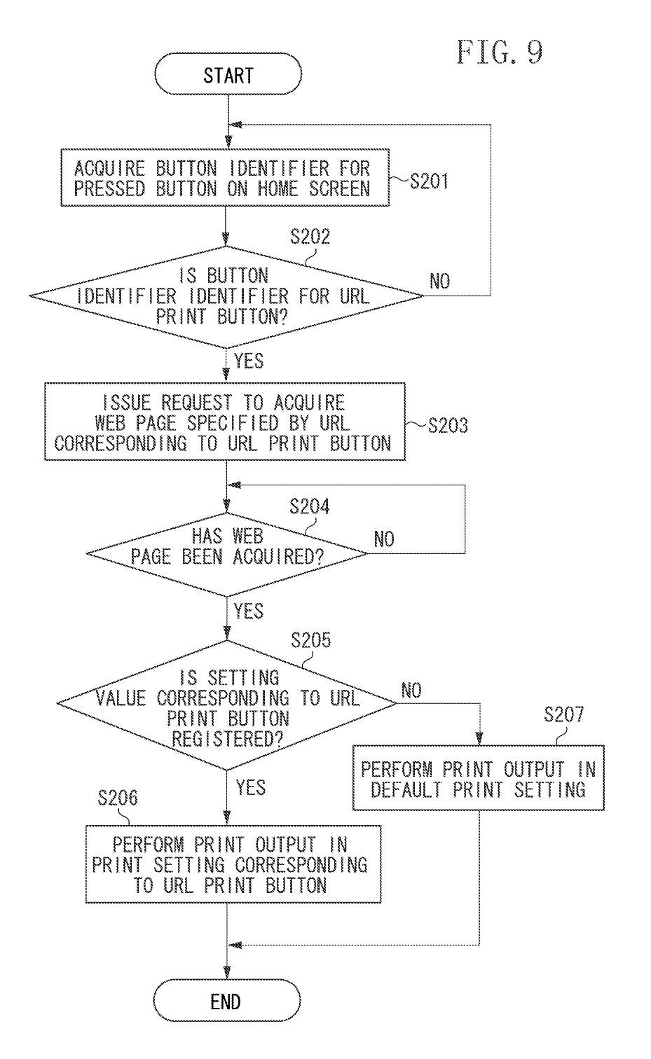

FIG. 9 illustrates a procedure performed when URL printing is performed, triggered by pressing the URL print button (the weather forecast button 504 or the newspaper button 505) on the home screen 501 illustrated in FIG. 5.

In step S201, the MFP 10 first acquires the button identifier 602 corresponding to the arrangement position of the button pressed by the user on the home screen 501 (index 601). In step S202, the MFP 10 then determines whether the acquired button identifier 602 is an identifier for the URL print button. If it is determined that the button identifier 602 is not the identifier for the URL print button (NO in step S202), the processing returns to step S201.

If it is determined that the button identifier 602 is the identifier for the URL print button (YES in step S202), then in step S203, the MFP 10 issues a request to acquire a web page specified by the URL 403 corresponding to the button identifier 602. The request is issued via the wireless LAN-I/F 18 or the wired LAN-I/F 19. In step S204, the MFP 10 determines whether the web page has been acquired. If the web page has not been acquired (NO in step S204), the MFP 10 waits until the web page has been acquired. If it is determined that the web page has been acquired (YES in step S204), then in step 3205, the MFP 10 determines whether the setting value 704 corresponding to the button identifier 602 is registered as a print setting. If it is determined that the setting value 704 is registered (YES in step S205), then in step S206, the CPU 11 instructs the printing unit 15 to perform printing in the print setting (the setting value 704) corresponding to the URL print button. Thus, the MFP 10 performs print output according to a content of the print setting by the user.

If it is determined that the setting value 704 is not registered (NO in step S205), then in step S207, the MFP 10 instructs the printing unit 15 to perform printing in a default print setting. Thus, the MFP 10 performs print output according to a content of the default print setting.

Thus, according to the first exemplary embodiment, the procedure for the print setting when the web page is printed is performed only once. Therefore, usability is improved.

In the first exemplary embodiment, the example of the case where the processing for registering the URL print button is performed on the side of the PC 20 has been described. In a second exemplary embodiment, the processing for registering a URL print button is performed on the side of an MFP 10. A hardware configuration of the MFP 10 and a PC 20 is similar to that in the first exemplary embodiment. In the second exemplary embodiment, the MFP 10 includes a functional block of a registration unit 204 in the PC 20. More specifically, when a CPU 21 executes an MFP application, a function of the registration unit 204 is implemented while the setting table 103 is replaced with a setting table 203 having the content described in the first exemplary embodiment. More specifically, the MFP 10 browses a web page via a communication control unit 205, acquires a URL of the web page, and registers (records) the acquired URL, together with print setting information, as a URL print button in the setting table 203. The registered URL print button is displayed on a display unit 141. A main control unit 101 determines the layout of a screen when the URL print button is displayed on the display unit 141 using a UI component held in a UI component holding unit 102.

Thus, in the second exemplary embodiment, the URL print button can be registered only by the MFP 10. The user only needs to operate the registered URL print button to print data acquired from the web page. Thus, a procedure for making a print setting when the web page is printed is performed only once. Therefore, usability is improved.

### [Modification]

While the second exemplary embodiment has been described on the premise that the MFP 10 browses the web page and acquires data from the web page, a URL which is accessed via a web browser on a PC 20 side may be registered. In this case, the PC 20 acquires the data from a web page instead of the MFP 10, and the MFP 10 performs only printing according to print setting information.

In the above-described image forming apparatus, access information and image formation setting information are associated with a functional image. Thus, a procedure for the image formation is simplified, and usability is significantly improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2016-031682, filed Feb. 23, 2016, which is hereby incorporated by reference herein in its entirety.

What is claimed is:

1. An image forming apparatus comprising:
a holding unit configured to hold identification information about a functional image in which access information for enabling acquisition of data from the outside and setting information about image formation of the data are associated with each other;
a display unit configured to display the functional image specified by the identification information on a predetermined operation screen;
an operation acceptance unit configured to accept an operation for the functional image which is being displayed;
a data acquisition unit configured to acquire the data using the access information associated with the functional image, triggered by the acceptance of the operation; and
an image forming unit configured to form an image according to the setting information for the acquired data.

2. The image forming apparatus according to claim 1, wherein the access information is a URL of a web page.

3. The image forming apparatus according to claim 2,
wherein the web page is a page which can be browsed via a specific browser, and
the access information is a URL accessible via an external apparatus loaded with the specific browser.

4. The image forming apparatus according to claim 1, further comprising
an interface which communicates with an external apparatus comprising a registration unit configured to register the functional image,
wherein the display unit displays the functional image received from the external apparatus.

5. The image forming apparatus according to claim 4,
wherein the image forming unit comprises a printing mechanism for printing the data acquired by the data acquisition unit, and
the setting information about image formation is print setting information for the acquired data, and
the registration unit registers the print setting information, associating the print setting information with the functional image.

6. The image forming apparatus according to claim 5, wherein the printing mechanism prints the acquired data according to the print setting information in a case where the print setting information is registered, and prints the data according to default print setting information in a case where the print setting information is not registered.

7. The image forming apparatus according to claim 1, further comprising
a registration unit configured to register the functional image,
wherein the data acquisition unit acquires the data using the access information associated with the registered functional image.

8. An information processing apparatus comprising:
an interface which communicates with an image forming apparatus having an operation panel;
a registration unit configured to register access information for enabling acquisition of data from the outside and setting information about image formation of the data, associating the access information and the setting information with identification information about a functional image; and
an image processing unit configured to transmit the registered functional image to the image forming apparatus and display the functional image on the operation panel.

9. The information processing apparatus according to claim 8, wherein the access information is a URL of a web page.

10. The information processing apparatus according to claim 9, further comprising
a browser capable of browsing the web page,
wherein the browser acquires the data instead of the image forming apparatus.

11. A method performed by an image forming apparatus having an operation panel, the method comprising:
holding a URL for getting to data on a web page which can be browsed via a predetermined browser and, setting information about image formation of the data, associating the URL and the setting information with a functional image;
displaying the functional image on the operation panel;
accepting an operation for the functional image which is being displayed to acquire the data by referring to access information associated with the functional image; and
forming an image according to the setting information for the acquired data.

12. A non-transitory computer readable storage medium storing a program for causing a computer to perform a method for controlling an image forming apparatus having an operation panel, the control method comprising:
holding a URL for getting to data on a web page which can be browsed via a predetermined browser and setting information about image formation of the data, associating the URL and the setting information with a functional image;
displaying the functional image on the operation panel;
accepting an operation for the functional image which is being displayed to acquire the data by referring to access information associated with the functional image; and
forming an image according to the setting information for the acquired data.
